(19) United States
(12) Patent Application Publication
(10) Pub. No.: US 2017/0014976 A1
(43) Pub. Date: Jan. 19, 2017

(54) LOW TENSION TWEEZERS

(71) Applicant: Aven, Inc., Ann Arbor, MI (US)

(72) Inventors: Mohamedi Mike Shahpurwala, Ann Arbor, MI (US); M. Nadeem Akhtar, Ann Arbor, MI (US)

(21) Appl. No.: 14/800,942

(22) Filed: Jul. 16, 2015

(51) Int. Cl. B25B 9/02

(52) U.S. Cl. CPC B25B 9/02

(57) ABSTRACT

A tweezers includes first and second arms which diverge away from each other from joined first ends. A plate is interposed between and joined to the first and second ends of the first and second arms to space the first and second ends apart. Each arm includes a handle extending from the diverging portion through a transition segment to a tip extending to a second end. The transition segment is a linear segment disposed at an obtuse interior angle with respect to an inner surface of the adjacent handle of each arm and an obtuse exterior angle with respect to an outer surface of the arm to transition into the tip.

### BACKGROUND

Tweezers are commonly used to grip and manipulate thin, usually delicate articles. Manual force is exerted on two arms of the tweezers which are joined together at one end. The opposite tip ends of the arms can be brought together under tension at typically point contact for handling delicate articles.

Operators of tweezers, during a course of a workday, exerts fingertip pressure on the tweezer arms numerous times leading to tiredness and finger strain which can interfere with the delicate work operation as well as injuring the worker's fingers and hand.

It would be desirable to provide tweezers which addresses these problems.

### SUMMARY

There is disclosed a tweezers which requires a low amount of tension or pressure to move the tips of each tweezer arm together. In addition, the tips are disposed so that when the tips are moved into contact with an article longer in length or extent of the tips are disposed in parallel to grasp the article over a greater extent or distance of the article to spread out the grasping force over a larger surface area of the delicate articles.

In one aspect, the tweezers include first and second arms, each having opposed first and second ends. A plate is interposed between the first and second ends of the first and second arms. The first and second ends of each of the first and second arms are joined to the first end of the other of the first and second arms and to the plate. A diverging segment extends from the first ends, diverging away from the diverging segment of the opposed first and second arms. A handle extends from the diverging segment of each of the first and second arms. A tip is formed on each of the first and second arms terminating in the seconds ends of the first and second arms. Each tip has a planar inner surface opposed from a planar inner surface of the opposed tip. A transition segment is interposed between the handle and the tip of each of the first and second arms. The transition segment has a linear extent and disposed at an obtuse interior angle with respect to an inner surface of the first and second arms and an exterior obtuse angle between an exterior surface of the transition segment and the tip of the first and second arms. The tips of the first and second arms are springily biased apart and movable in substantial parallel contact over a linear extent of the tips extending from the second ends when force is exerted on the handles of the first and second arms.

The first and second arms can taper smoothly in width from the handle through the tip to the second ends.

The tips can have a V-shape width.

The handle of each of the first and second arms can define a substantially linear segment.

The first and second ends of the first and second arms are longitudinally co planar.

The tips are arcuately disposed away from a longitudinal axis between the spaced portion or segments of the first and second arms.

The diverging segments springly bias the first and second arms away from the first ends.

The handles of each of the first and second arms have a greater thickness than the adjacent diverging segments of the first and second arms.

The transition segment can define linear segments.

The diverging segment of each of the first and second arms diverges arcuately from the first ends of the respective first and second arms.

The handles on the first and second arms diverge from each other.

### BRIEF DESCRIPTION OF THE DRAWING

The various features, advantages, and other uses of the present low tension tweezers will become more apparent by referring to the following detailed description and drawing in which:

FIG. 1 is a top plan view of one aspect of a low tension tweezers;

FIG. 2 is a side elevational view of the low tension tweezers shown in FIG. 1;

FIG. 3 is an enlarged, partial, side elevational view showing the low tension tweezers of FIGS. 1 and 2 closed under manual pressure gripping an article;

FIG. 4 is top plan view of another aspect of the low tension tweezers;

FIG. 5 is a top plan view of another aspect of the low tension tweezers;

FIG. 6 is a top plan view of another aspect of a low tension tweezers; and

FIG. 7 is a side elevational view of the low tension tweezers shown in FIG. 6.

### DETAILED DESCRIPTION

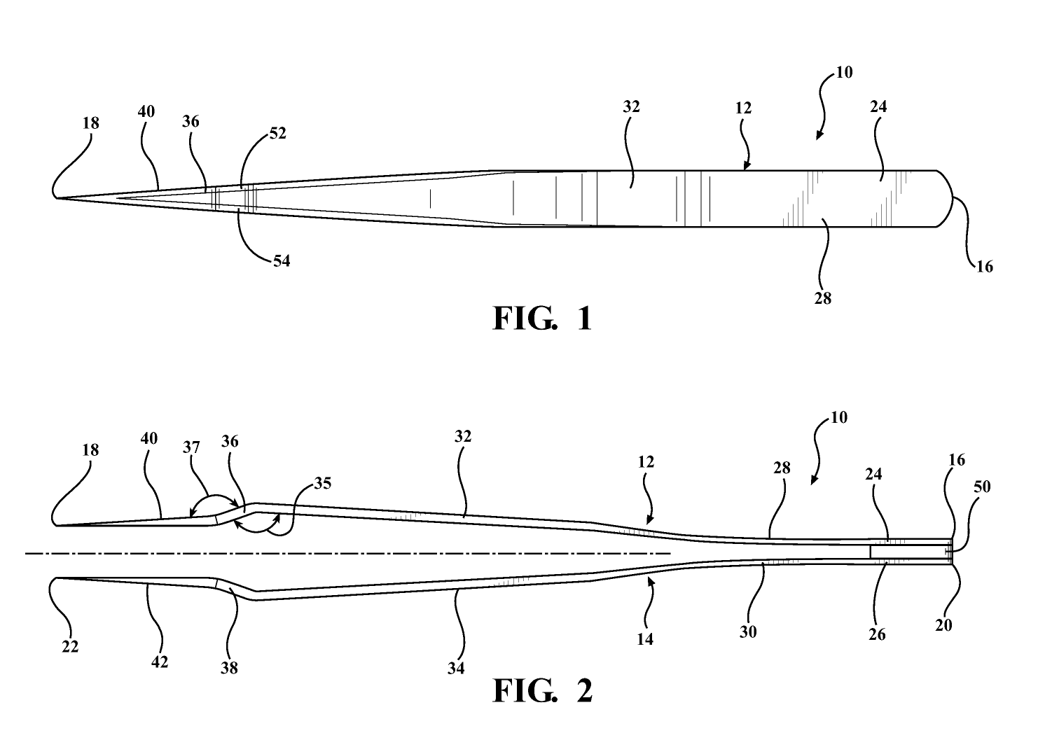

Referring now to the drawing and to FIGS. 1 and 2 in particular, there is depicted one aspect of a tweezers 10 which requires low tension or force levels to manually move the tip ends of the tweezer arms together to grasp and hold an object.

In the tweezers 10 shown in FIGS. 1 and 2, first and second arms 12 and 14 are identical; but oriented in mirror opposed orientations. Each arm of the first and second 12 and 14 has first and second ends. For example, the first arm 12 has a first end 16 and an opposed second end 18. The second arm 14 has a first end 20 and an opposed second end 22.

The first and second arms 12 and 14 may be formed of a suitable material, such as carbon steel, titanium, aluminum, or an anti-magnetic, anti-acid stainless steel, for example.

At least a portion of the first and second arms 12 and 14 may have an exterior coating to protect first and second arms 12 and 14 as well to provide secure gripping of the first and second arms 12 and 14.

A portion of the first and second arms 12 and 14 extending from the respective first ends 16 and 20 defines a generally first linear end portion 24 and 26, respectively. A plate 50 is interposed between the first linear end portions 24 and 26 and is fixed to the first linear end portions 24 and 26 by joining means, such as a weld, a rivet, adhesive, etc. The plate 50 spaces the first and second arms 12 and 14 apart at the first linear end portions 24 and 26 to contribute to the low tension operation capability of the tweezers 10.

The first end portions 24 and 26 of each of the first and second arms 12 and 14 are spaced apart and merge into diverging segments 28 and 30, respectively. The diverging segments 28 and 30 may be formed a cold rolling operation to provide a spring biasing action to the first and second arms 12 and 14.

The diverging segments 28 and 30 of the first and second arms 12 and 14 then transition respectively into handles 32 and 34. The handles 32 and 34, in the tweezers 10 shown in FIGS. 1 and 2, have an enlarged thickness compared to the diverging segments 28 and 30 and the later described tips. As shown in FIG. 2, the handles 32 and 34, which may have a ribbed, scored, or otherwise textured outer surface for easy gripping, having generally linear extent between the diverging segments 28 and 30 and transition segments 36 and 38.

The first and second arms 12 and 14 include a transition segment 36 and 38, respectively, which angle inward toward the opposed first or second arm 12 or 14. An elongated tip 40 and 42 is respectively formed on each of the first and second arms 12 and 14 extending between the transition segments 36 and 38 to the second ends 18 and 22.

As shown in FIG. 1, each of the first and second arms 12 and 14 has a generally constant width extending from the first end 16 and 20 to a point intermediate the linear extent of the handles 32 and 34. The side edges of the first and second arms 12 and 14 then taper smoothly in a V-shape to a sharp point through the balance of the arms 12 and 14, the transition segments 36 and 38 and the tips 40, 42 to the second ends 18, 22. The tapered end portion of the first and second arms 12 and 14 may have radiused outer side edges 52 and 54.

For the following description, by example only and not limitation, the first and second arms 12 and 14 are described as having a width, in the plan view of FIG. 1 between the opposed outer side edges, a length extending along a longitudinal axis between the first and second ends 16, 18 and 20, 22, and a thickness shown in FIG. 2, between an outer surface extending between the side edges and an inner or interior surface.

As shown in FIG. 2, in a normal relaxed position of the first and second arms 12 and 14, the first and second arms 12 and 14 diverge away from each other between the diverging segments 28 and 30 and the beginning of the transition segments 36 and 38. The handles 32 and 34 also diverge apart from each other.

The transition segments 36 and 38 define a linear segment on each of the first and second arms 12 and 14 which is disposed at an obtuse interior angle 35 with respect to an inner surface of the first or second arms 12 and 14 facing toward the opposed first and second arm 12 and 14 and at an exterior obtuse angle 37 with respect to an outer surface of the first or second arms 12 and 14 and the tips 40 and 42, respectively. The transition segments 36 and 38 dispose the tips 40, 42, which generally have linear corner facing surfaces, closer together so that than the distance between the inner surfaces of the handles 32 and 34 as shown in FIG. 3, when manual tension or force is exerted on the handles 32 and 34 to move the tips 40 and 42 move toward each other in parallel over a long distance 43, FIG. 3, to grasp an article over a large extent of the inner surface of the tips 40 and 42. The gripping force exerted by the first and second arms 12 and 14 on the typically delicate or fragile articles 45 is distributed over a larger surface area of the articles 45, rather than at point contact as in prior art tweezers. In addition, the transition segments 36 and 38 in conjunction with the plate 50 reduced the amount of force or tension required to move the tips 40 and 42 together in gripping contact with an article as compared to prior art tweezers.

It would be understood that different applications may require different shapes for the first and second arms 12 and 14 of the tweezers 10. Any or all of the various segments or portions each of the first and second arms 12 and 14, such as the first end portions 24 and 26, the diverging segments 28 and 30, the handles 32 and 34, the transition segments 36 and 38, and the tips 40 and 42 may have varying lengths.

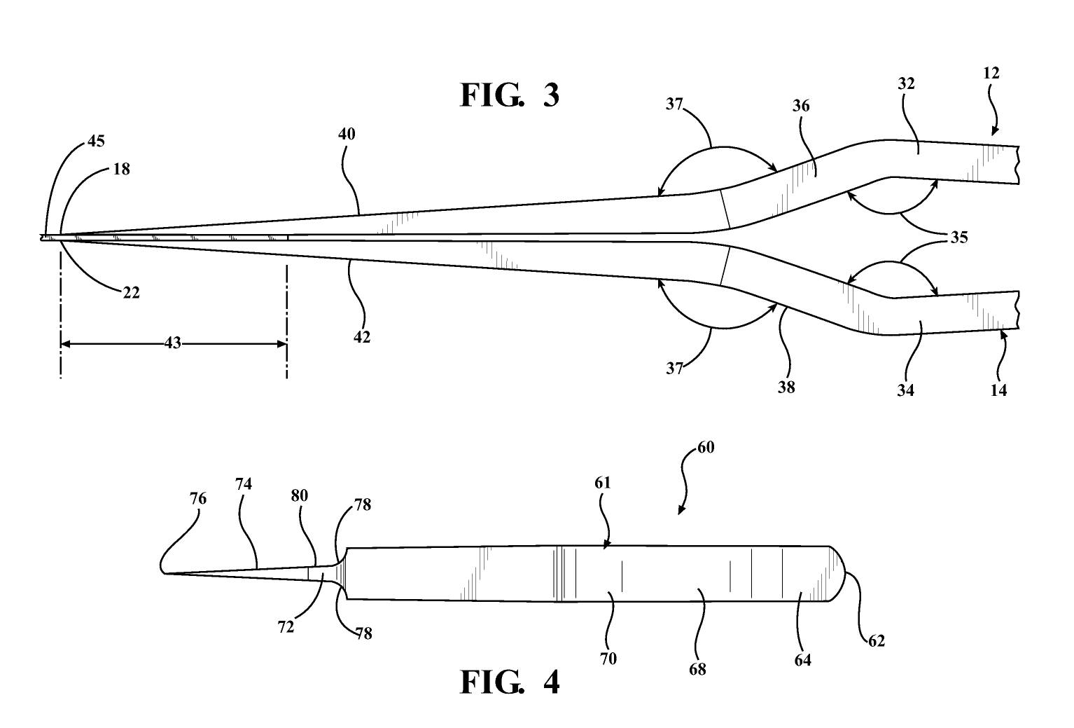

FIG. 4 depicts another aspect of a tweezers 60 which has first and second arms, with only the first arm 61 shown in FIG. 4, which have identical constructed side elevations as the first and second arms 12 and 14 of the tweezers 10 shown in FIGS. 1-3. In this aspect, the first arm 61 includes the first end 62 and a first end portion 64 extending from the first end 62. The first end portion 64 is joined to the plate 50 and the opposed first end portion of the opposed arm as described above and shown in FIGS. 1 and 2. The first arm 61 includes diverging segments 68 which merges into a handle 70. A transition segment 72 is interposed between the handle 70 and a tip 74 which extends to a second end 76 of the first arm 61.

In this aspect, the first and second arms, such as the first arm 61, generally have a constant width from the first end 62 to the beginning of the transition segment 72. The transition segment 72, in addition to having the same interior and exterior obtuse angles 35, 37 as the transition segments 36 and 38 shown in FIGS. 1 and 2, has a width which reduces through an arcuate radius shoulder 78 to a narrower portion 80 which than merges into the tip 74. The tip 74 tapers in width to a sharp point at the second end 76.

The operation of the tweezers 60 shown in FIG. 4 is identical to that described above for the tweezers 10 shown in FIGS. 1-3.

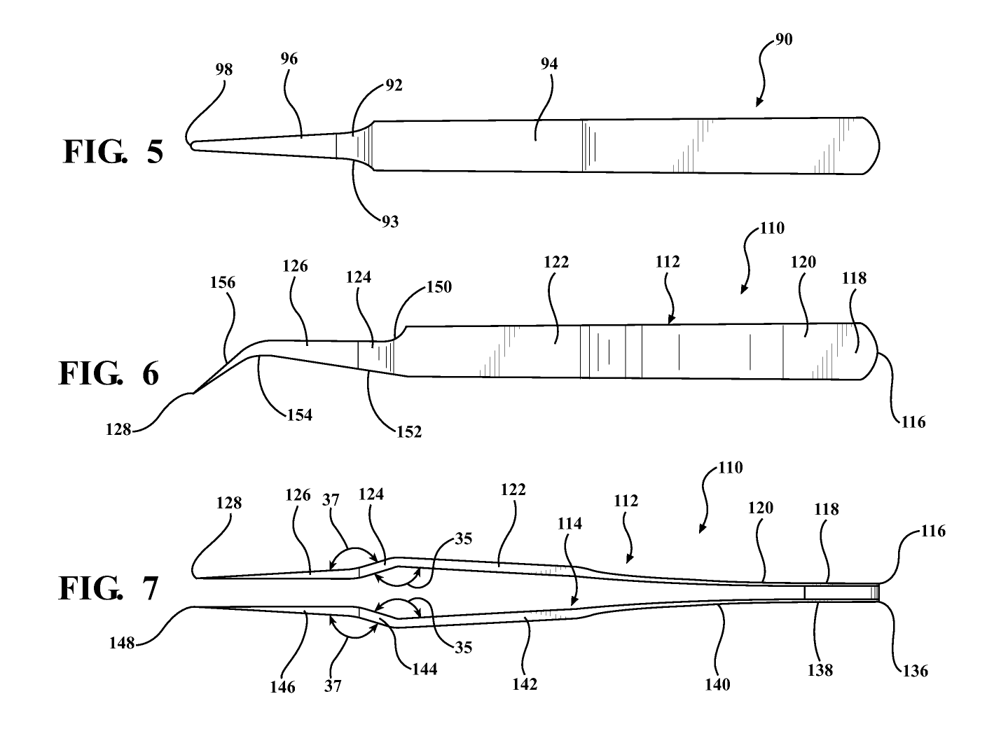

FIG. 5 depicts another aspect of a tweezers 90 which is similar to the tweezers 60 shown in FIG. 4, but includes a shallower radius in the shoulder 93 of a transition segment 92 between the handle 94 and the tip 96 in each of the first and second arms of the tweezers 90. This forms the width of the transition segment 92 adjacent the radius and shoulder 93 with a larger dimension than that of the segment 80 in the tweezers 60 shown in FIG. 4. The tips 96, while tapering in width to a second end 98 of the first and second arms, have a greater width thereby presenting a flatter surface than the tips 74 in the tweezer 60 shown in FIG. 4.

Another aspect of the tweezer 110 is shown in FIGS. 6 and 7. The tweezers 110 includes first and second arms 112 and 114 which are generally constructed and operate in the same manner as the first and second arms 12 and 14 in the tweezers 10 shown in FIGS. 1-3.

For example, the first arm 112 has a first end 116, a first linear end portion 118 extending from the first end 116, a diverging segment 120 which diverges away from the diverging segment of the opposed second arm 114, a handle 122, a transition segment 124, and a tip 126 which extends to a sharp point at a second end 128 of the first arm 112.

Likewise, the second arm 114 includes a first end 136 and a first linear end portion 138 extending from the first end 136. A diverging segment 140 extends from the first end portion 138 away from the diverging segment 120 of the opposed first arm 112. A handle 142 extends from the diverging portion 140 to a transition segment 144 which angularly blends into a tip 146 extending to a sharp point at a second end 148 of the second arm 114.

In this aspect, as shown in FIG. 6, the first and second arms 112 and 114 have a generally constant width in a front orientation from the first ends 116, 136 to the beginning of the transition segments 124, 144. A single radius shoulder 150 is formed along one side edge of each of the first and second arms, such as the first arm 112 shown in FIG. 6, at the beginning of the transition segment 124. The opposed side edge 152 of the first arm 112 has linear angled shape through the length of the transition segment 124. At the same time, the transition segment 124 bends in the width orientation at the interior obtuse and exterior obtuse angles 35, 37 shown in FIG. 7 to move the tips 126 and 146 of the first and second arms 112 and 114 closer together and in parallel for the low tension and distributed force capability of the tweezers 110, as described above.

The tips 126 and 146 taper smoothly from the transition segments 124 and 144 to an obtuse bend 154 in a width orientation having a generally constant radius which merges into a constantly tapering second end portion 156 of the tips 126 and 146.

Referring back to FIGS. 1-3, the tweezers 10 are depicted in a normally unbiased, normal relaxed state. A worker's fingers in contact with the handles 32 and 34 of the first and second arms 12 and 14 exert force or tension on the handles 32 and 34 to move the tips 40 and 42 toward each other, generally in parallel for a distance 43 so that an elongated extent or length of the tips 40 and 42 contact the article 45, as shown in FIG. 3 to distribute the tension or force exerted on the article 45 over a greater extent of the article 45 to minimize damage to the article 45.

The diverging segments 28 and 30, in combination with the diverging handles 32 and 34 and the obtuse interior and obtuse exterior angles of the transition segments 36 and 38 contribute to a significant reduction in the tension or force required to move the tips 40 and 42 of the first and second arms 12 and 14 together. This minimizes the amount of force exerted on the typically delicate articles grasped by tweezers 10 as well as significantly reducing the repeated force required on the part of the worker thereby minimizing potential injury to the worker's fingers, hands and wrists.

What is claimed is:

1. A tweezers comprising:
first and second arms, each having opposed first and second ends, the first and second arms disposed on opposite sides of a longitudinal axis extending between the first and second ends of the first and second arms;
a plate interposed between the first and second ends of the first and second arms, the first and second ends of each of the first and second arms joined to the plate;
a diverging segment extending from each of the first ends, diverging away from a diverging segment of an opposed one of the first and second arms with respect to the longitudinal axis;
a handle extending from the diverging segment of each of the first and second arms along the longitudinal axis;
a tip formed on each of the first and second arms terminating at the seconds ends of the first and second arms, each tip having a planar inner surface opposed from a planar inner surface of an opposed tip along the longitudinal axis;
a transition segment interposed between the handle and the tip of each of the first and second arms, the transition segment having a linear extent and disposed at an obtuse interior angle with respect to an inner surface of the first and second arms and an exterior obtuse angle between the transition segment and an outer surface of the tips of the first and second arms; and
the first and second arms springily biased apart by the diverging segments and movable to bring the tips into a substantial parallel contact over a linear extent of the tips extending from the second ends when force is exerted on the handles of the first and second arms.

2. The tweezers of claim 1 wherein:
the first and second arms taper smoothly in width from the handle through the tip to the second end.

3. The tweezers of claim 1 wherein:
the tips have a V-shape width.

4. The tweezers of claim 1 wherein:
the handle of each of the first and second arms defines a substantially linear segment.

5. The tweezers of claim 1 wherein:
the first and second ends are longitudinally co-planar.

6. The tweezers of claim 1 wherein:
the tips are arcuately disposed away from a longitudinal axis between the first and second arms.

7. The tweezers of claim 1 wherein:
the diverging segments springly bias the first and second arms away from the first ends.

8. The tweezers of claim 1 wherein:
the handles of each of the first and second arms has a greater thickness than the adjacent diverging segments of the first and second arms.

9. The tweezers of claim 1 wherein:
the transition segments define linear transition segments.

10. The tweezers of claim 1 wherein:
the diverging segment of each of the first and second arms diverges arcuately from the first ends of the respective first and second arms.

11. The tweezers of claim 1 wherein:
the handles on the first and second arms diverge from each other.

12. The tweezers of claim 1 wherein:
the handle of each of the first and second arms defines a substantially linear segment; and
the handles on the first and second arms diverge from each other.

13. The tweezers of claim 12 wherein:
the handles of each of the first and second arms has a greater thickness than the adjacent diverging segments of the first and second arms.

14. A tweezers comprising:
first and second arms, each having opposed first and second ends, the first and second arms disposed on opposite sides of a longitudinal axis extending between the first and second ends of the first and second arms;
a plate interposed between the first and second ends of the first and second arms, the first and second ends of each of the first and second arms joined to the plate;
a diverging segment extending from each of the first ends, diverging away from a diverging segment of an opposed one of the first and second arms with respect to the longitudinal axis, the diverging segments springingly biasing the first and second arms away from the first end outwardly with respect to the longitudinal axis;
a handle extending from the diverging segment of each of the first and second arms along the longitudinal axis, the handle of each of the first and second arms defining a substantially linear segment;
a tip formed on each of the first and second arms terminating at the seconds ends of the first and second arms, each tip having a planar inner surface opposed from a planar inner surface of an opposed tip along the longitudinal axis;
a transition segment interposed between the handle and the tip of each of the first and second arms, the transition segment having a linear extent and disposed at an obtuse interior angle with respect to an inner surface of the first and second arms and an exterior obtuse angle between the transition segment and an outer surface of the tips of the first and second arms; and
the first and second arms springily biased apart by the diverging segments and movable to bring the tips into a substantial parallel contact over a linear extent of the tips extending from the second ends when force is exerted on the handles of the first and second arms.

15. The tweezers of claim 14 wherein:
the handles of each of the first and second arms has a greater thickness than the adjacent diverging segments of the first and second arms.

16. The tweezers of claim 14 wherein:
the handles on the first and second arms diverge from each other.
